(19) United States
(12) Patent Application Publication
(10) Pub. No.: US 2021/0051394 A1
(43) Pub. Date: Feb. 18, 2021

(54) Airband (EarBud and Headband Combination)

(71) Applicant: Stephanie Ann Green, Milwaukie, OR (US)

(72) Inventor: Stephanie Ann Green, Milwaukie, OR (US)

(21) Appl. No.: 16/541,127

(22) Filed: Aug. 14, 2019

(51) Int. Cl. H04R 1/10

(52) U.S. Cl. CPC H04R 1/1091; H04R 1/1016; H04R 2420/07; H04R 2201/023; H04R 1/1041

(57) ABSTRACT

The purpose of this patent application is to obtain a patent on the AirBand, which is a combination between commercially available Earbuds and a commercially available fashion headband. The main purpose for this invention is to provide a convenient and discrete storage place for Earbuds when not in use. When the user needs the Earbuds, they, unsnap it from the headband and start using it, to talk. When they are finished talking, they snap the Earbuds back onto the headband and keep it there until they need to use it or charge it. If the user needs to charge it, he she unsnaps the Earbuds from the headband and place it on the charger and charge it how the user normally charges the Earbuds.

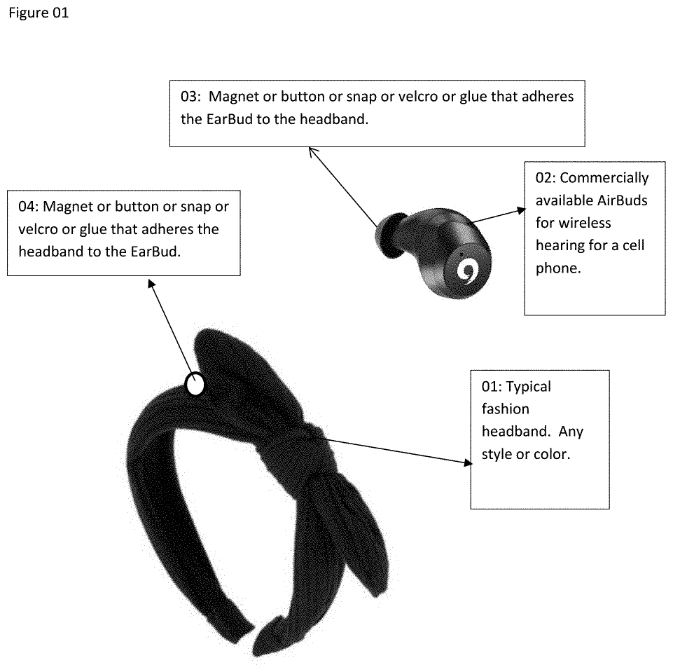

Stephanie Ann Green, a United States Citizen and resident of Portland Oreg. has invented the AirBand which is a combination of Earbuds (wireless apparatus that is inserted into the ear for wireless hearing of cell phone audible sounds) and a headband combined to make a new idea and function.

### CROSS-REFERENCE TO RELATED APPLICATIONS

This section is non-applicable to this patent application.

### STATEMENT REGARDING FEDERALLY SPONSORED RESEARCH OR DEVELOPMENT

(If Applicable)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention takes two existing commercially available products and combines them for a specific purpose or utility function. The main impetus for the AirBand, is to provide a convenient place for Earbuds (or any wireless apparatus that is inserted into the ear for wireless hearing of cell phone audible sounds) to store for easy access. Also, the main reason is to not to look obvious when using Earbuds that are connected through a wireless headset, or in a hard to find storage box that users have to quickly find in order to answer their phone. Many users never like to carry a case or wear a visible headset around their neck that contains obvious Earbuds. Out of need to have a discreet way to wear Earbuds, Stephanie invented the AirBand, which makes the Earbuds look discreet while looking fashionable. The AirBand will come in all styles, designs and colors. The Earbud is connected to the headband by either a magnet, snap, velcro or glue. The Earbuds will be attached in a discreet manner to the headband. The Earbuds will be incorporated into the design of the headband.

Stephanie Ann Green is a full-time working mother of 3 kids with an MBA. Her house is comprised of a family of five and her kids are always losing their wireless Earbuds, Stephanie noticed that existing accessories for Earbuds were lacking and wanted something more discrete and more fashionable. Hence the need for the invention of the AirBand. The AirBand's utility is a holding or storage facility, which is the headband, for the Earbuds to be connected to in order to access them quickly and efficiently as well as discretely while being fashionable.

### BRIEF SUMMARY OF THE INVENTION

As mentioned above, there is a huge market and need for this product. The invention is comprised of combining two separate commercially available products on the market currently into something that functions as its own utility (Earbuds and Headband combined make the AirBand along with adherence material).

### BRIEF DESCRIPTION OF THE SEVERAL VIEWS OF THE DRAWING

Please refer to separate diagram of AirBand. Each element is properly labeled.

### DETAILED DESCRIPTION OF THE INVENTION

There is no other invention like this one the market. The process is simple with existing materials on the market. All materials are on the market currently so it's a matter of assembling existing materials that are commercially available. This invention requires the use of Earbuds and a headband and an adherence material such as magnets, snaps, velcro or glue. The adherence material is installed on the Earbuds and the same adherence material is placed on the headband and then the two are joined together in order to make a convenient and discreet storage space for the Earbuds. Essentially the two items are adhered together temporarily until the user needs the Earbuds then he/she pulls the Earbuds off the headband and places them into their ears and starts using them, When the user is finished, he/she adheres the Earbuds back onto the headband. The Earbuds will be designed neatly into the headband to try and conceal it as much as possible or make it blend in with the design.

1. AirBand is a combination of Earbuds (also known as a wireless apparatus that is inserted into the ear for wireless hearing of cell phone audible sounds) and a fashion headband that are temporarily adhered together in which makes a new idea and function. The user will wear the headband like a normal headband, but Earbuds, when not in use, are adhered to it in a discreet manner.
(a) An Earbud (wireless apparatus that is inserted into the ear for wireless hearing of cell phone audible sounds) that is adhered to a headband with adherence material such as magnets, glue, velar) and/or snaps.
(b) A fashion headband that has been designed to house Earbuds by means of an adherence material whereby the Earbuds are temporarily affixed to the headband until the user needs to use the Earbuds.
(c) A normal fashion, headband that has Earbuds attached to it.
In this claim Earbuds and headbands are already known and are not new. The headband with an Earbuds attached to it is the apparatus that is being claimed and patented.
For purposes of this patent, an Earbud is defined as a very small headphone, worn inside the ear in a wireless capacity.
For purposes of this patent, a headband is defined as a band of fabric worn around the head as a decoration or to keep the hair or perspiration off the face.
